(19) United States
(12) Patent Application Publication
(10) Pub. No.: US 2020/0270869 A1
(43) Pub. Date: Aug. 27, 2020

(54) HANDRAIL FIXING COMPONENT

(71) Applicant: APLUS HARDWARE CORP., Taipei City (TW)

(72) Inventor: YUNG HUANG CHUANG, TAIPEI CITY (TW)

(21) Appl. No.: 16/283,993

(22) Filed: Feb. 25, 2019

(51) Int. Cl. E04F 11/18

(52) U.S. Cl. CPC E04F 11/1804; F16M 13/02

(57) ABSTRACT

The handrail fixing component for supporting a handrail is provided with a casing, a power supply, and a controlling assembly. The casing forms a light transmission hole and at least one detecting hole. The controlling assembly has a circuit board, an illuminating element, a brightness sensor, and a proximity sensor. The illuminating element is mounted on the circuit board and faces toward the light transmission hole. The brightness sensor and the proximity sensor are mounted on the circuit board and face toward the detecting hole. The handrail fixing component may turn on the illuminating element automatically when a creature moves close to the handrail fixing component if the brightness of the environment is not adequate so that the nearby wall and ground are lightened. With the light, people can see the handrail clearly, and find or hold the handrail to avoid falling down.

### BACKGROUND OF THE INVENTION

### 1. Field of the Invention

The present invention relates to a building structure, especially to a handrail structure.

### 2. Description of the Prior Arts

Handrails are one of the very common building structures. In the conventional technical means, some of the handrails are fixed on a wall via handrail fixing components. For example, handrails may be mounted beside stairs so people can hold the handrails when going upstairs or downstairs, which makes people safer. In addition, handrails may be mounted at a place where people are prone to falling down, such as in a bathroom or an elevator. In fact, there are a lot of factors making people fall down. For instance, when it is too dark at night, people may not be able to notice protrusions, objects, water, etc. on the ground.

To overcome the shortcomings, the present invention provides a handrail fixing component to mitigate or obviate the aforementioned problems.

### SUMMARY OF THE INVENTION

The main objective of the present invention is to provide a handrail fixing component that is capable of illuminating the environment when people move close to the handrail fixing component.

The handrail fixing component is capable of being mounted on a wall and a handrail is capable of being mounted on the handrail fixing component. The handrail fixing component has a casing, a power supply, a controlling assembly, a mounting base, and a support. The casing forms a light transmission hole and at least one detecting hole. The power supply is mounted in the casing. The controlling assembly is mounted in the casing, is electrically connected to the power supply, and comprises a circuit board, an illuminating element, a brightness sensor, and a proximity sensor. The circuit board is electrically connected to the power supply. The illuminating element is mounted on and electrically connected to the circuit board. The illuminating element faces toward the light transmission hole of the casing. The brightness sensor is mounted on and electrically connected to the circuit board. The brightness sensor faces toward the at least one detecting hole of the casing. The proximity sensor is mounted on and electrically connected to the circuit board and the proximity sensor faces toward the at least one detecting hole of the casing. The mounting base has a first end and a second end, the first end of the mounting base is securely mounted on the casing, and the second end of the mounting base is securely mounted on the wall. The support has a first side and a second side, the first side of the support is connected to the casing, and the handrail is securely mounted on the second side of the support.

Consequently, the handrail fixing component of the present invention may turn on the illuminating element automatically when an object moves close to the handrail fixing component if the brightness of the environment is not adequate so that the nearby wall and ground are lightened. With the light, people can see the handrail clearly, and find or hold the handrail to avoid falling down.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a handrail fixing component in accordance with the present invention;

FIG. 2 is a lateral view of the handrail fixing component in FIG. 1;

FIG. 3 is an exploded view of the handrail fixing component in FIG. 1;

FIG. 4 is a sectional view of the handrail fixing component in FIG. 1;

FIG. 5 is a sectional view of the handrail fixing component across line A-A in FIG. 2; and

FIG. 6 is an exploded view of a controlling assembly and a lower part of a casing of the handrail fixing component in FIG. 1.

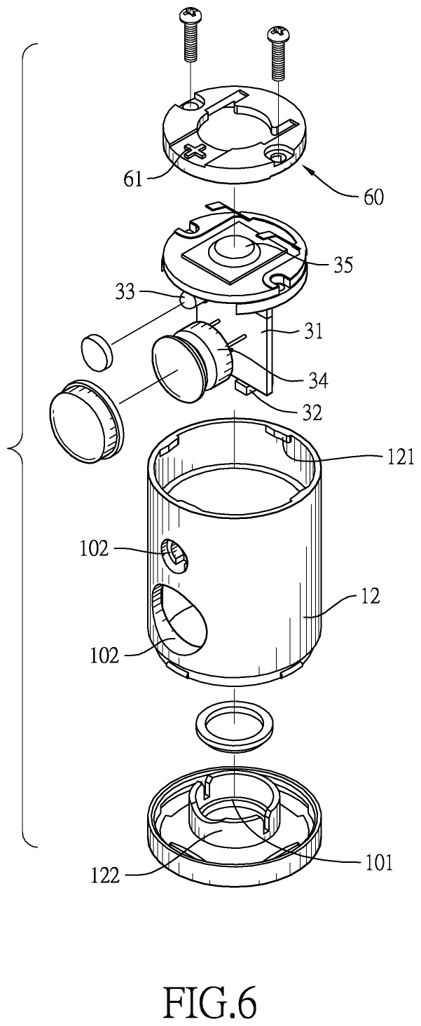

### DETAILED DESCRIPTION OF THE PREFERRED EMBODIMENTS

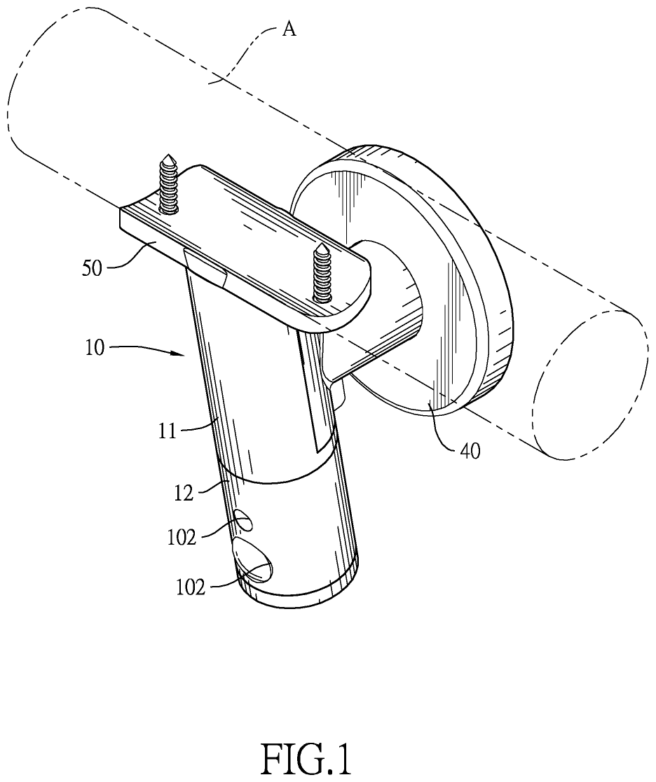

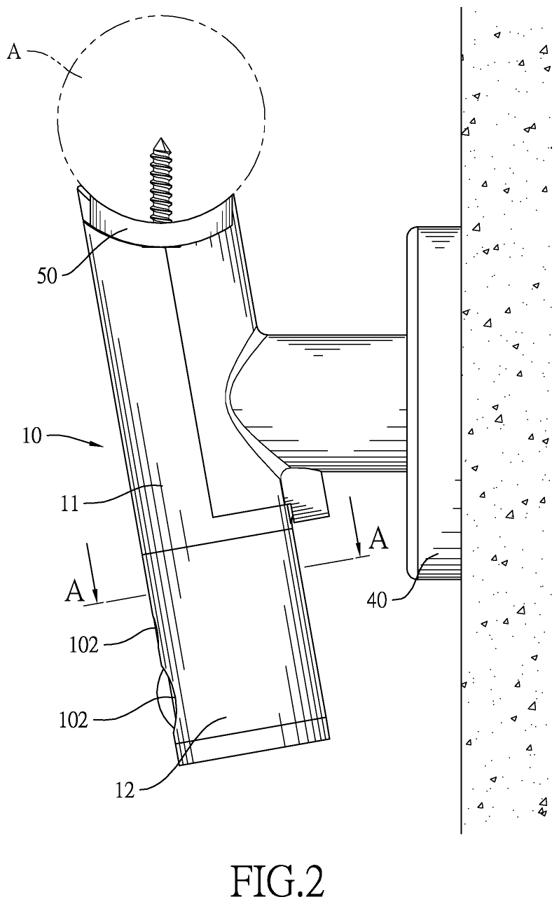

Please refer to FIGS. 1, 2 and 5. A handrail fixing component according to the present invention is provided. A handrail A may be mounted on the handrail fixing component. The handrail fixing component comprises a casing 10, a power supply 20, a controlling assembly 30, a mounting base 40, and a support 50.

The casing 10 forms a light transmission hole 101 and at least one detecting hole 102. The light transmission hole 101 is located at a bottom surface of the casing 10. The at least one detecting hole 102 is located at a lateral surface of the casing 10. The casing 10 may comprise an upper part 11 and a lower part 12. The lower part 12 is detachably mounted on the upper part 11. The light transmission hole 101 and the at least one detecting hole 102 are formed on the lower part 12. In this embodiment, the casing 10 has two detecting holes 102, but it is not limited thereto.

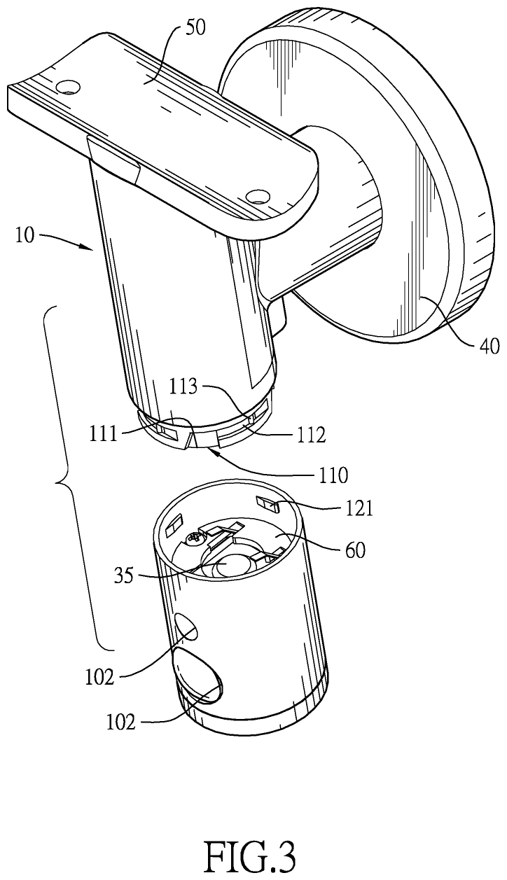

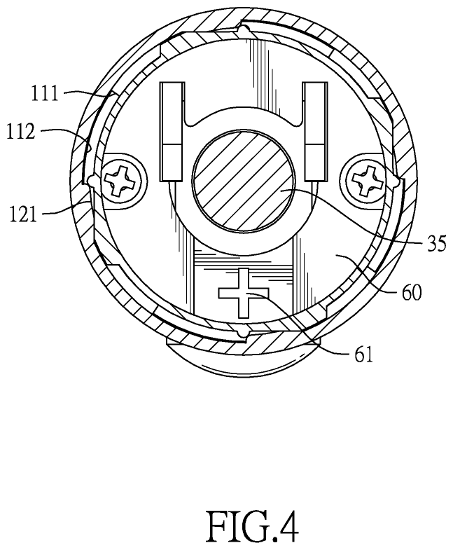

Then please refer to FIGS. 3 and 4. In this embodiment, the upper part 11 of the casing 10 comprises a plurality of L-grooves 110 and, correspondingly, the lower part 12 of the casing 10 comprises a plurality of blocks 121. Each one of the blocks 121 is capable of being detachably received in a respective one of the L-grooves 110.

Each one of the L-grooves 110 is formed on an outer surface of a lower end of the upper part 11 of the casing 10 and, correspondingly, each one of the blocks 121 is formed on an inner surface of an upper end of the lower part 12 of the casing 10. Precisely, each one of the L-grooves 110 comprises a longitude channel 111, a latitude channel 112, and an obstruction 113. The longitude channel 111 extends upward from an end surface of the lower end of the upper part 11 of the casing 10. In other words, the longitude channel 111 has a lower end and an upper end, the lower end of the longitude channel 111 is an open end formed at the end surface of the lower end of the upper part 11.

The latitude channel 112 has a first end and a second end. The latitude channel 112 extends laterally from the upper end of the longitude channel 111. The first end of the latitude channel 112 communicates with the upper end of the longitude channel 111, and the second end of the latitude channel 112 is a closed end. The obstruction 113 is in the latitude channel 112 and close to the second end of the latitude channel 112.

Therefore, each one of the blocks 121 is capable of passing through the longitude channel 111 and the latitude channel 112 of a respective one of the L-grooves 110, and then is limited between the obstruction 113 and the second end of the longitude channel 111, which makes the lower part 12 of the casing 10 fixed firmly on the upper part 11 of the casing 10 but still easy to be removed from the upper part 11.

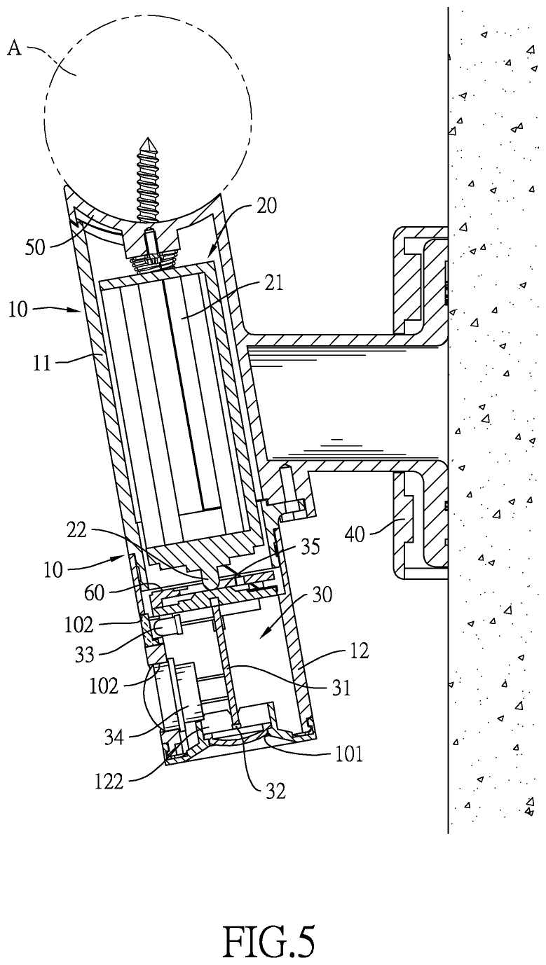

Then please refer to FIG. 5. The power supply 20 is mounted in the casing 10. In this embodiment, the power supply 20 may be a battery holder 21 detachably mounted in the upper part 11 of the casing 10. With the lower part 12 can be removed from the upper part 11, the battery holder 21 in the upper part 11 can be removed from the upper part 11 and thus replacement of the battery (s) in the battery holder 21 is easy.

The controlling assembly 30 is mounted in the casing 10 and electrically connected to the power supply 20. In this embodiment, the controlling assembly 30 is received in the lower part 12. The controlling assembly 30 comprises a circuit board 31, an illuminating element 32, a brightness sensor 33, and a proximity sensor 34. The circuit board 31 is electrically connected to the power supply 20. The illuminating element 32, the brightness sensor 33, and the proximity sensor 34 are mounted on the circuit board 31 and electrically connected to the circuit board 31.

The illuminating element 32 faces toward the light transmission hole 101 of the casing 10, which means the light emitted from the illuminating element 32 passes through the light transmission hole 101. In other words, where the illuminating element 32 faces toward is where the illuminating element 32 illuminates. Therefore, the illuminating element 32 can illuminate a space under the handrail fixing component of the present invention. The brightness sensor 33 and the proximity sensor 34 face toward the two detecting holes 102 of the casing 10 respectively, but in another embodiment the brightness sensor 33 and proximity sensor 34 may face toward the same detecting hole 102. Precisely, where the sensors face toward is the detecting direction of the sensors. With the illuminating element 32 and the brightness sensor 33 facing toward different directions, when the illuminating element 32 is illuminating, the brightness sensor 33 may not be interfered by the light emitted from the illuminating element 32. In other words, the brightness sensor 33 can detect the correct brightness.

The mounting base 40 has a first end and a second end. The first end of the mounting base 40 is securely mounted on the casing 10 and the second end of the mounting base 40 is securely mounted on a wall. The support 50 has a first side and a second side. The first side of the support 50 is connected to the casing 10 and the handrail A can be mounted on the second end of the support 50. In this embodiment, the mounting base 40 and the support 50 are mounted on the upper part 11, but it is not limited thereto.

During operation, the brightness sensor 33 keeps detecting a brightness of an environment. If the brightness is adequate, the proximity sensor 34 is turned off, so that the illuminating element 32 does not work, either, which saves energy. If the brightness is inadequate, the proximity sensor 34 is turned on and starts to detect whether an object or a creature moves close or not. Then, when the proximity sensor 34 detects an object moving close, the illuminating element 32 is turned on and thereby illuminates the wall and the ground around the handrail fixing component of the present invention, which allows people to see the handrail A clearly.

Then please refer to FIGS. 4 and 5. The handrail fixing component selectively comprises a ring 60. The ring 60 is mounted between the power supply 20 and the controlling assembly 30. The ring 60 comprises an electrode icon 61. The electrode icon 61 is formed on a surface of the ring 60, said surface facing toward the power supply 20. With the electrode icon 61, the user can determine the orientation of the power supply 20. In this embodiment, the electrode icon 61 is a cross mark, which means a positive electrode of the power supply 20 should face toward the ring 60.

Please refer to FIG. 5 again. The power supply 20 selectively forms a protrusion hereinafter referred to as a first protrusion 22. The first protrusion 22 protrudes toward the controlling assembly 30. Therefore, the first protrusion 22 selectively passes through a center of the ring 60 and abuts the controlling assembly 30 so that the power supply 20 is electrically connected to the controlling assembly 30.

Similarly, the controlling assembly 30 selectively forms a protrusion hereinafter referred to as a second protrusion 35. The second protrusion 35 protrudes toward the power supply 20 and the ring 60 encloses the second protrusion 35. In this embodiment, thicknesses of the first protrusion 22 and the second protrusion 35 are less than a thickness of the ring 60, but the summation of the thicknesses of the first protrusion 22 and the second protrusion 35 is larger than the thickness of the ring 60. Therefore, when the power supply 20 is mounted in the casing 10 with the correct orientation, the first protrusion 22 may abut the second protrusion 35; when the power supply 20 is mounted in the casing 10 with a wrong orientation, the power supply 20 and the controlling assembly 30 are isolated by the ring 60 and cannot be electrically connected.

In another embodiment, the controlling assembly 30 may not comprise the second protrusion 35 but the thickness of the first protrusion 22 of the power supply 20 is greater than that of the ring 60. Therefore, as long as the power supply 20 is mounted with the correct orientation, the first protrusion 22 can pass through the ring 60 and be electrically connected with the controlling assembly 30.

The casing 10 selectively comprises a shading board 122 located between the illuminating element 32 and the detecting hole 102. Precisely, the shading board 122 is located between the illuminating element 32 and the brightness sensor 33. Therefore, the light emitted from the illuminating element 32 is shaded by the shading board 122 and may not leak via the at least one detecting hole 102. Precisely, the shading board 122 is securely mounted on and in the lower part 12 of the casing 10.

Consequently, the handrail fixing component of the present invention may turn on the illuminating element 32 automatically when a creature moves close to the handrail fixing component if the brightness of the environment is not adequate so that the nearby wall and ground are lightened. With the light, people can see the handrail A clearly, and find or hold the handrail A to avoid falling down.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A handrail fixing component capable of being mounted on a wall and being capable of having a handrail mounted on the handrail fixing component; the handrail fixing component comprising:
a casing forming a light transmission hole and at least one detecting hole;
a power supply mounted in the casing;
a controlling assembly mounted in the casing, electrically connected to the power supply, and comprising:
a circuit board electrically connected to the power supply;
an illuminating element mounted on and electrically connected to the circuit board, the illuminating element facing toward the light transmission hole of the casing;
a brightness sensor mounted on and electrically connected to the circuit board, and the brightness sensor facing toward the at least one detecting hole of the casing; and
a proximity sensor mounted on and electrically connected to the circuit board, and the proximity sensor facing toward the at least one detecting hole of the casing;
a mounting base having a first end and a second end, the first end of the mounting base securely mounted on the casing, and the second end of the mounting base securely mounted on the wall; and
a support having a first side and a second side, the first side of the support securely mounted on the casing, and the handrail securely mounted on the second side of the support.

2. The handrail fixing component as claimed in claim 1, wherein the casing comprises:
an upper part; the mounting base and the support mounted on the upper part; and
a lower part detachably mounted on the upper part.

3. The handrail fixing component as claimed in claim 2, wherein:
the upper part of the casing comprises
a plurality of L-grooves formed on an outer surface of a lower end of the upper part of the casing;
the lower part of the casing comprises
a plurality of blocks formed on an inner surface of an upper end of the lower part of the casing; each one of the blocks detachably received in a respective one of the L-grooves.

4. The handrail fixing component as claimed in claim 3, wherein each one of the L-grooves comprises:
a longitude channel having a lower end and an upper end; the longitude channel extending upward from an end surface of the lower end of the upper part of the casing; the lower end of the longitude channel being an open end;
a latitude channel having a first end and a second end; the latitude channel extending laterally from the upper end of the longitude channel; the first end of the latitude channel communicating with the upper end of the longitude channel; and
an obstruction in the latitude channel;
wherein each one of the blocks is capable of passing through the longitude channel and the latitude channel of a respective one of the L-grooves and is limited between the obstruction and the second end of the longitude channel

5. The handrail fixing component as claimed in claim 2, wherein
the controlling assembly is received in the lower part; and
the light transmission hole and the at least one detecting hole are formed on the lower part of the casing.

6. The handrail fixing component as claimed in claim 4, wherein
the controlling assembly is received in the lower part; and
the light transmission hole and the at least one detecting hole are formed on the lower part of the casing.

7. The handrail fixing component as claimed in claim 1, wherein the light transmission hole is located at a bottom surface of the casing, and the at least one detecting hole is located at a lateral surface of the casing.

8. The handrail fixing component as claimed in claim 6, wherein the light transmission hole is located at a bottom surface of the casing, and the at least one detecting hole is located at a lateral surface of the casing.

9. The handrail fixing component as claimed in claim 1, wherein the power supply is a battery holder detachably mounted in the casing.

10. The handrail fixing component as claimed in claim 8, wherein the power supply is a battery holder detachably mounted in the upper part of the casing.

11. The handrail fixing component as claimed in claim 9 further comprising:
a ring mounted between the power supply and the controlling assembly;
wherein, the power supply forms:
a protrusion protruding toward the controlling assembly, selectively passing through a center of the ring to abut the controlling assembly, and electrically connected to the controlling assembly.

12. The handrail fixing component as claimed in claim 10 further comprising:
a ring mounted between the power supply and the controlling assembly;
wherein, the power supply forms:
a protrusion protruding toward the controlling assembly, selectively passing through a center of the ring to abut the controlling assembly, and electrically connected to the controlling assembly.

13. The handrail fixing component as claimed in claim 11, wherein a side, facing to the power supply, of the ring forms an electrode icon.

14. The handrail fixing component as claimed in claim 12, wherein a side, facing to the power supply, of the ring forms an electrode icon.

15. The handrail fixing component as claimed in claim 1, wherein the casing comprises:
a shading board between the illuminating element and the at least one detecting hole.

16. The handrail fixing component as claimed in claim 14, wherein the casing comprises:
a shading board between the illuminating element and the at least one detecting hole.
